(19) United States
(12) Patent Application Publication
(10) Pub. No.: US 2018/0025063 A1
(43) Pub. Date: Jan. 25, 2018

(54) Analysis Engine and Method for Analyzing Pre-Generated Data Reports

(71) Applicant: Huawei Technologies Co., Ltd., Shenzhen (CN)

(72) Inventors: Puneet Gupta, Karnataka (IN); V Vimal Das Kammath, Karnataka (IN)

(21) Appl. No.: 15/721,165

(22) Filed: Sep. 29, 2017

Related U.S. Application Data
(63) Continuation of application No. PCT/CN2015/095705, filed on Nov. 26, 2015.

(30) Foreign Application Priority Data
Mar. 31, 2015 (IN) IN1696/CHE/2015

(51) Int. Cl. G06F 17/30

(52) U.S. Cl. CPC G06F 17/30554; G06F 17/3053; G06F 17/30528; G06Q 10/06

(57) ABSTRACT

A method for analyzing pre-generated data reports, wherein the method includes receiving selection of first and at least one second data report of pre-generated data reports. The pre-generated data reports include report elements, report layout of report elements, metadata and data of report elements. The report layout of the first data report is compared with report layout of the at least one second data report. Matching of report elements and metadata of the first data report with corresponding report elements and metadata of the at least one second data report is determined. A comparison data report and an aggregated data report comprising data for the report elements of the first data report combined with corresponding data for the corresponding report elements of the at least one second data report is generated.

### CROSS-REFERENCE TO RELATED APPLICATIONS

This application is a continuation of International Patent Application No. PCT/CN2015/095705 filed on Nov. 26, 2015, which claims priority to Indian Patent Application No. IN1696/CHE/2015 filed on Mar. 31, 2015. The disclosures of the aforementioned applications are hereby incorporated by reference in their entireties.

### TECHNICAL FIELD

The present disclosure relates to the field of data analysis and comparison system, and in particular, to a method and an analysis engine for assessing pre-generated data reports.

### BACKGROUND

Generally, a user associated to an enterprise includes, but is not limited to, an administrator, a developer, a tester, a manager, an editor, an Information Technology (IT) personnel, Business Intelligence (BI) specialists, data scientists etc. The user provides one or more queries to fetch one or more data results (i.e. query results for the one or more queries). The one or more data results are fetched by a query execution engine associated to the enterprise from a data store associated to the enterprise. The data store stores complex and large data in a form of data blocks which are generally indexed, sorted and compressed. The data store provides efficient tools to explore the one or more data results in the data store to provide response to one or more queries specified by the user. The one or more data results are fetched as reports by a report engine to provide overall view of the one or more data results in a report format. The one or more reports can be in a format which includes, but is not limited to, Hyper Text Markup Language (HTML), Extensible Markup Language (XML), Portable Document Format (PDF), plain/rich text format, spreadsheet format, and the like. The report engine provides the one or more reports in a form of a visual trend. Particularly, the visual trend provides visualization of the one or more reports to view the one or more data results pertaining to the one or more queries. The visual trend may include, but is not limited to, pie chart, bar graphs, histogram, box plots, run charts, forest plots, fan charts, control chart, tables, and pivots etc. For example, considering the user raises a query to view “XYZ” network traffic distribution in smartphones in “XXX” and “YYY” countries. The reports showing traffic of the “XYZ” network distribution in various brands of smartphones is fetched from the data store. FIG. 1A shows the traffic distribution of the “XYZ” network in the various brands of smartphones in “XXX” and “YYY” countries in the form of the bar graphs.

In a scenario, the user performs one or more operations which includes, without limiting, comparison and aggregation of the one or more reports. For example, the user would like to compare the “XYZ” network traffic distribution in “XXX” country with “XYZ” network traffic distribution in “YYY” country. Usually, data of a country resides in a corresponding country data store or database. Particularly, data of the “XXX” country resides in a “XXX” country database which is physically located in the “XXX” country and data of the “YYY” country resides in a “YYY” country database located physically located in the “YYY” country. In such a case, it's a great challenge to access different country's database to fetch the data of the corresponding because the access to the country's database is not enabled to the user for analysis. Also, there is a problem that the report of the “XXX” country is generated by analyst associated to the “XXX” country's database. In such a case, the analysts may not have access and required permissions to run queries on the “YYY” country's database. Thus, the analyst cannot generate a comparison or aggregation report for the two countries. Also, in case of big data, some data may get deleted periodically from the database to provide space for new data and only necessary or minimum information is retained in the database. In such case, the actual data is not available for re-analysis in future and hence generation of comparison and/or aggregation report may not possible after data deletion. In case, the analyst has access to both the databases and the corresponding system supports merging data from two different sources, then there may result in wastage of system resources in case of big data where the amount of data to be scanned for the query is huge. For example, the comparison and/or the aggregation having huge data in the one or more reports can take a few minutes to a few hours along with huge consumption of a processor and a memory.

Further, the analysis of the different reports is a great challenge. Traditionally, report elements defined for a report template are static as shown in FIG. 1B. The form in which the report has to be viewed is already defined beforehand which limits the user to perform analysis with other reports.

Particularly, from the illustrated FIG. 1B, a report engine parses the report template. The report engine reads the queries from the report template and executes the queries using a query engine. The report engine collects query results for the queries and passes the query results to a rendering engine associated to the report engine. The rendering engine renders the various parts of the report based on the report template and query results. Thereafter, the rendering engine provides the final report. Particularly, when the user opens the HTML report, the report containing the HTML contents including the layout and the formatted data, cascading style sheet (CSS) files for styles and the charts and/or the images for resources are rendered for display as shown in FIG. 1C. Such way of report rendering limits the user to perform analysis since the values from the report elements for example, chart may not be clear and also there exists difficulty in comparing a chart to a table.

In an alternative approach, the user can compare and/or aggregate the one or more reports manually. But, manual operation of the comparison and/or the aggregation is tedious and is complex with more time consumption since a report having a chart for example may not show all the report contents. Hence, there is a problem to locate each of the data from each of the one or more reports and perform the comparison and/or the aggregation manually.

One of the other approaches teaches real-time data visualization of streaming data. Particularly, the other approach discloses a real-time analysis system which provides a chart 100 for a real-time data as shown in FIG. 1D. The numeral 114a, 114b, . . . , 114j are the bars which defines the real-time data. In addition to the real-time data, the real-time analysis system provides an option 102 to compare the real-time data with a past data such as yesterday's data, last week's data, last month's data, or last year's data. However, the other approach fails to perform the comparison upon loss of the raw data and involves wastage of the system resources to generate the comparison report from the raw data. Further, the other approach performs the online comparison over a network, hence, offline analysis is not possible since there is a problem when network failure exists. In such a case, the comparison is not possible when the network is disconnected.

### SUMMARY

An objective of the present disclosure is to render data report dynamically in real-time. Another objective of the present disclosure is to analyze pre-generated data reports having similar report elements to perform comparison and/or aggregation in an offline platform.

The present disclosure relates to a method for analyzing pre-generated reports. The method includes one or more steps performed by an analysis engine particularly an offline analysis engine. The first step of the method includes receiving selection of a first data report and at least one second data report of a plurality of pre-generated data reports. Each of the plurality of pre-generated data reports includes report elements, a report layout of the report elements, metadata of the report elements and data of the report elements. In an embodiment, the data report is a packaged report generated using information of queries, elements, configuration information of the elements and layout information of each of one or more report templates. The report elements refer to kind of a visual trend contained by each report template of the one or more report templates. The visual trend may include, but is not limited to, pie chart, bar graphs, histogram, box plots, run charts, forest plots, fan charts, control chart, table and pivot. In an embodiment, the configuration information refers to configuration (i.e. metadata) of the elements. The data of report elements refers to the data for each of the report elements. The method further includes comparing the report layout of the first data report with the report layout of the at least one second data report. The method further includes determining matching of the report elements and the metadata of the first data report with each of the corresponding report elements and metadata of the at least one second data report based on comparison. Based on the determination, the method further includes performing generating a comparison report including data for the report elements of the first data report compared with corresponding data for the corresponding report elements of the at least one second data report and generating an aggregated report including data for the report elements of the first data report combined with corresponding data for the corresponding report elements of the at least one second data report.

In an embodiment, each data report of the plurality of data reports is generated by retrieving queries, layout details, elements and configuration information of elements of each of the data reports. The method further includes performing at least one of generating a data record including query data for the queries of each data reports. The method further performs generating meta information of each elements using the configuration information of the elements of each data report. The method further performs generating layout information of each data report using the layout details of each data reports. The method further includes aggregating the data record, the meta information and the layout information along with a corresponding analysis engine. The method further includes rendering dynamically each data report by the analysis engine using the elements, the data record, the meta information and the layout information contained in the data report. In an embodiment, the comparison report is generated based on the metadata of each of the report elements of the first data report and the at least one second data report. The aggregated report is generated based on the metadata of each of the report elements of the first data report and the at least one second data report. The method further includes generating by the analysis engine, a visual trend for each data of the report elements for the comparison report.

An analysis engine is disclosed in the present disclosure for analyzing pre-generated data reports. The analysis engine is configured to receive selection of a first data report and at least one second data report of a plurality of pre-generated data reports. Each of the plurality of pre-generated data reports includes report elements, a report layout of the report elements, metadata of the report elements and data of the report elements. The analysis engine is configured to compare the report layout of the first data report with the report layout of the at least one second data report. The analysis engine is configured to determine matching of the report elements and the metadata of the first data report with each of the corresponding report elements and metadata of the at least one second data report based on comparison. Based on the determination, the analysis engine is configured to performing generating a comparison report including data for the report elements of the first data report compared with corresponding data for the corresponding report elements of the at least one second data report. The analysis engine is configured to generating an aggregated report including data for the report elements of the first data report combined with corresponding data for the corresponding report elements of the at least one second data report.

The analysis engine is associated to a generation engine which is configured to generate each data report of the plurality of data reports by retrieving queries, layout details, elements and configuration information of elements of each data reports. Then, a data record including query data for the queries of each data report is generated. Meta information of each elements using the configuration information of the elements of each data reports is generated. Layout information of each data reports using the layout details of each data report is generated. Further, the data record, the meta information and the layout information along with a corresponding analysis engine are aggregated. The analysis engine is configured for rendering dynamically each data report using the data record, the meta information and the layout information. The analysis engine is configured to generate the comparison report based on the metadata of each of the report elements of the first data report and the at least one second data report. The analysis engine is configured to generate the aggregated report based on the metadata of each of the report elements of the first data report and the at least one second data report. The analysis engine is further configured for generating a visual trend for each data of the report elements for the comparison report.

The present disclosure relates to a non-transitory computer readable medium including operations stored thereon that when processed by at least one processing unit cause an analysis engine to perform one or more actions by performing the acts of receiving selection of a first data report and at least one second data report of a plurality of pre-generated data reports, wherein each of the plurality of pre-generated data reports includes report elements, a report layout of the report elements, metadata of the report elements and data of the report elements. Then, the report layout of the first data report is compared with the report layout of the at least one second data report. Then, matching of the report elements and the metadata of the first data report with each of the corresponding report elements and metadata of the at least one second data report is determined based on comparison. At least one of is performed, based on the determination, generating a comparison report including data for the report elements of the first data report compared with corresponding data for the corresponding report elements of the at least one second data report, and generating an aggregated report including data for the report elements of the first data report combined with corresponding data for the corresponding report elements of the at least one second data report.

A computer program for performing one or more actions on an analysis engine is disclosed by the present disclosure. The computer program includes code segment for receiving selection of a first data report and at least one second data report of a plurality of pre-generated data reports, wherein each of the plurality of pre-generated data reports includes report elements, a report layout of the report elements, metadata of the report elements and data of the report elements. The computer program includes code segment for comparing the report layout of the first data report with the report layout of the at least one second data report. computer program includes code segment for determining matching of the report elements and the metadata of the first data report with each of the corresponding report elements and metadata of the at least one second data report based on comparison. The computer program includes code segment for performing, based on the determination, at least one of generating a comparison report including data for the report elements of the first data report compared with corresponding data for the corresponding report elements of the at least one second data report, and generating an aggregated report including data for the report elements of the first data report combined with corresponding data for the corresponding report elements of the at least one second data report.

In an embodiment, the present disclosure performs analysis of the data report. The present disclosure does not limit any analyst from any country to use any databases since each of the data report are pre-generated. In such a way, each of the data report without limitation can be used for analysis (i.e. to generate the comparison report and/or the aggregated data report). Also, in such a way, the analysis report can be generated with all the elements i.e. tables, pivot, chart, images etc. can be generated which provides better view to the analyst unlike in the prior arts.

The foregoing summary is illustrative only and is not intended to be in any way limiting. In addition to the illustrative aspects and features described above, further aspects, and features will become apparent by reference to the drawings and the following detailed description.

### BRIEF DESCRIPTION OF THE ACCOMPANYING DRAWINGS

The novel features and characteristic of the present disclosure are set forth in the appended claims. The embodiments of the present disclosure itself, however, as well as a preferred mode of use, further objectives and advantages thereof, will best be understood by reference to the following detailed description of an illustrative embodiment when read in conjunction with the accompanying drawings. One or more embodiments are now described, by way of example only, with reference to the accompanying drawings.

FIGS. 1A to 1D show diagrams illustrating generation of data reports using static report template and past data in accordance with an embodiment of the other approaches;

FIG. 2 shows exemplary block diagram illustrating an analysis engine of one or more data reports with processor and memory for analyzing pre-generated data reports in accordance with some embodiments of the present disclosure;

FIG. 3A shows a detailed block diagram illustrating an analysis engine with various modules and data for analyzing pre-generated data reports in accordance with some embodiments of the present disclosure;

FIG. 3B shows a detailed block diagram of an analysis engine with various engines for analyzing pre-generated data reports in accordance with some embodiments of the present disclosure;

FIG. 4 shows an exemplary diagram illustrating generation of data reports dynamically in accordance with some embodiments of the present disclosure;

FIG. 5 show exemplary diagram illustrating rendering contents of data reports in accordance with some embodiments of the present disclosure;

FIGS. 6A, 6B, 6C, 6D, 6E, and 6F show diagrams illustrating analyzing pre-generated data reports in accordance with some embodiments of the present disclosure;

FIGS. 7, 8, and 9 illustrate flowcharts of method for analyzing and pre-generation of the plurality of data reports along with rendering content of data reports in accordance with some embodiments of the present disclosure; and

FIG. 10 illustrates a block diagram of an exemplary computer system for implementing embodiments consistent with the present disclosure.

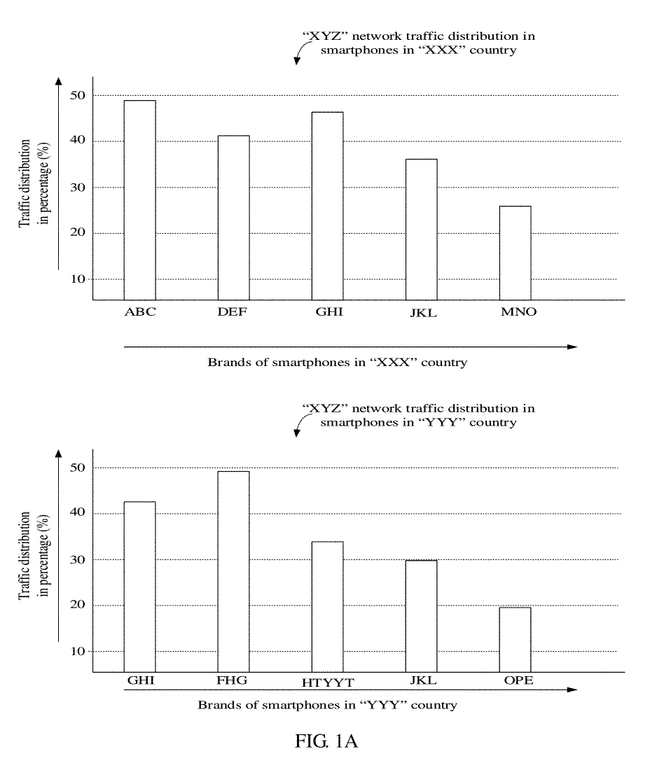

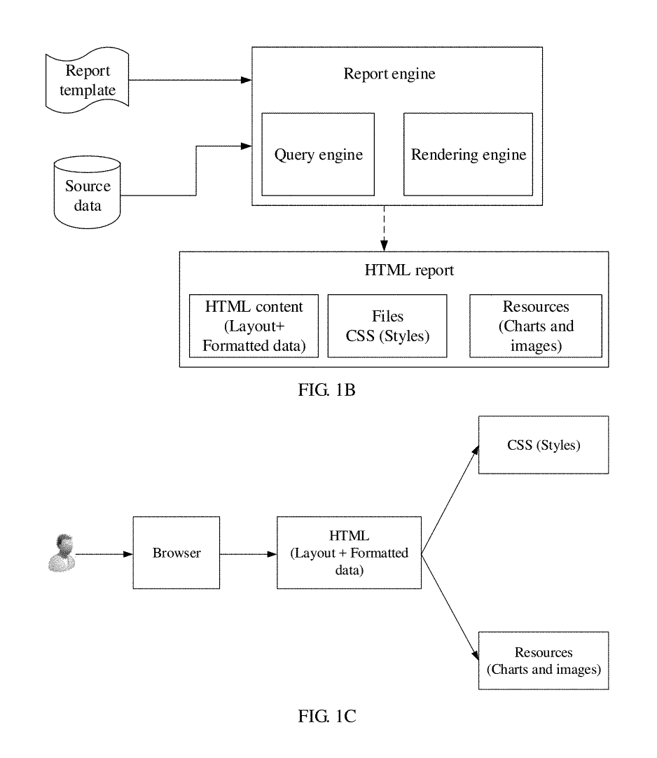

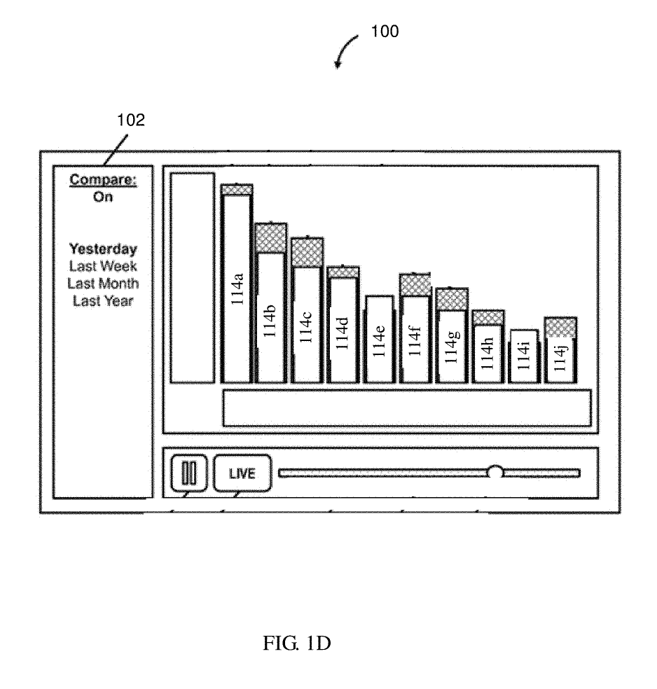

The figures depict embodiments of the present disclosure for purposes of illustration only. One skilled in the art will readily recognize from the following description that alternative embodiments of the structures and methods illustrated herein may be employed without departing from the principles of the present disclosure described herein.

### DETAILED DESCRIPTION

The many features and advantages of the embodiments are apparent from the detailed specification and, thus, it is intended by the appended claims to cover all such features and advantages of the embodiments that fall within the scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

The foregoing has broadly outlined the features and technical advantages of the present disclosure in order that the detailed description of the present disclosure that follows may be better understood. Additional features and advantages of the present disclosure will be described hereinafter, which form the subject of the claims of the disclosure. It should be appreciated by those skilled in the art that the conception and specific aspect disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

Embodiments of the present disclosure relate to analysis engine for analyzing pre-generated data reports. More particularly, the present disclosure is related to perform offline comparison and/or aggregation of one or more data reports in real-time and dynamically. Each of the one or more data reports are pre-generated with report contents which includes, without limitation, layout of report elements, the report elements, metadata of the report elements, and data of the elements by the analysis engine. The data report is rendered dynamically by the analysis engine using the report contents of the data report when a user opens the one or more data reports over a corresponding report browser. The browser may include for example HTML browser. The report contents of the data report along with the analysis engine that renders the report in the browser eliminate the need to have a statically pre-rendered reports as performed in traditional reporting systems. The pre-rendered reports have, for example, the report data as visual report elements pre-rendered as HTML elements such as table or image or text along with required formatting and browser alone is sufficient to render such a report. In case of data reports of the present disclosure, the analysis engine is required to render the report once the data report is opened in the browser. The analysis engine reads the report layout, report elements and data of the data report and renders the data report offline, in the report browser. From the one or more pre-generated data reports, the user selects a first data report which may act as a master report and at least one second data report to perform analysis with reference to the first data report. Hence, the first data report is used as a reference data report based on which comparison and/or aggregation of the first data report and the at least one second data report is carried out.

Henceforth, embodiments of the present disclosure are explained with the help of exemplary diagrams and one or more examples. However, such exemplary diagrams and examples are provided for the illustration purpose for better understanding of the present disclosure and should not be construed as limitation on scope of the present disclosure.

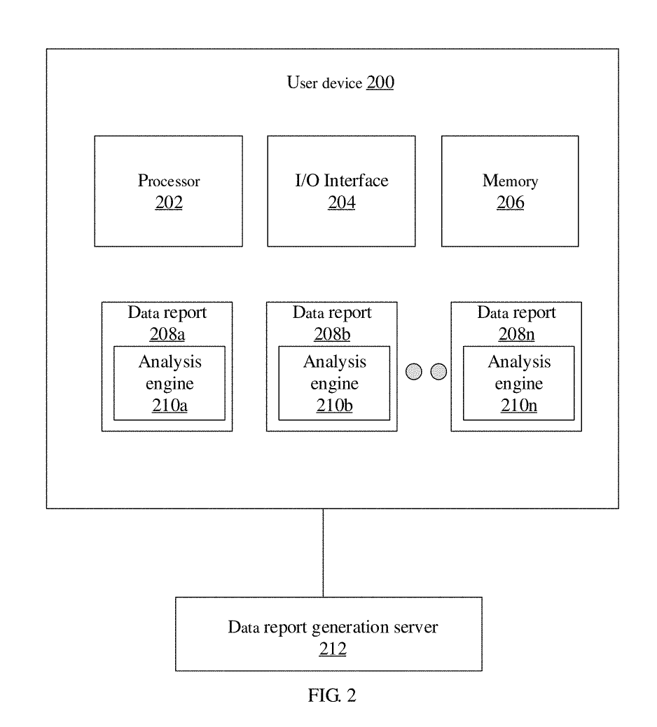

FIG. 2 shows exemplary block diagram illustrating a user device 200 with a processor 202, a memory 206, a plurality of pre-generated data reports 208a, 208b, . . . , 208n (collectively referred to 208) and an analysis engine 210a, 210b, . . . , 210n (collectively referred to 210) of the respective plurality of pre-generated data reports 208 in accordance with some embodiments of the present disclosure.

In one implementation, the user device 200 may be implemented in a variety of computing systems, such as a laptop computer, a desktop computer, a Personal Computer (PC), a notebook, a smartphone, a tablet, electronic book (e-book) readers, a workstation, a mainframe computer, a server, a network server, and the like. In one example, the user device 200 is associated to an enterprise. The user device 200 can be used by a user which may include a person associated to the enterprise. The user includes, but is not limited to, an administrator, a developer, a tester, a manager, an editor, an IT personnel, BI specialists, data scientists etc. In an embodiment, the user may include the user device 200 itself capable of performing such actions performed by the user such as those included in this disclosure.

The user device 200 further includes an Input/Output (I/O) interface 204 coupled to the processor 202, the memory 206 and the plurality of pre-generated data reports 208 including the analysis engine 210. In an embodiment, the user device 200 is communicatively connected to a data report generation server 212 associated to the enterprise. In an embodiment, the plurality of data reports 208 are pre-generated by the data report generation server 212. In one implementation, the data report generation server 212 can be the user device 200 which is configured to pre-generate the plurality of data reports 208. Each data report of the plurality of data reports 208 are pre-generated with predefined report contents by the data report generation server 212. In an embodiment, the plurality of data reports 208 are pre-generated to enable rendering the one or more data reports of the plurality of data reports dynamically in corresponding data report browser via the corresponding analysis engine 210. The rendered one or more data reports are viewable dynamically when the user accesses the one or more data reports for example over the browser using the predefined report contents of the corresponding one or more data reports independently. Additionally, the plurality of data reports 208 are pre-generated to perform analysis involving comparison and/or aggregation using any of the one or more data reports of the plurality of pre-generated data reports 208. In such a way, the analysis is performed in real-time. The detailed description on pre-generation of the plurality of data reports 208 by the data report generation server 212 is explained in following description.

In an embodiment, the user device 200 enables the user to select a first data report followed by at least one second data report among the plurality of pre-generated data reports 208. In an embodiment, each of the first data report and the at least one second data report been selected by the user, is received by the user device 200 from the data report generation server 212 through the I/O interface 204. The I/O interface 204 is configured to provide a visual trend relating to analysis of the plurality of pre-generated data reports 208 on a user interface (not shown) for displaying to the user. Particularly, the I/O interface 204 is configured to provide a comparison report and/or an aggregated report generated by the analysis engine of the first data report to the user interface.

The processor 202 may include at least one data processor for executing program components for rendering each data report of the plurality of data reports 208 and enabling offline comparison and/or aggregation analysis. The processor 202 is configured to receive the selected first data report and the at least one second data report through the I/O interface 204. The processor 202 is configured to perform the analysis which includes the comparison and/or aggregation using the analysis engine of the first data report being selected. In an embodiment, the analysis can be performed using analysis engine 210 of any of the plurality of pre-generated data reports 208. The processor 202 provides the results of the analysis to the user interface for display or viewing. In an embodiment, the processor 202 is enabled to perform analysis of the plurality of pre-generated data reports 208 using the analysis engine 210 along with one or more modules as described in detail in below description of the present disclosure.

The memory 206 is communicatively coupled to the processor 202. The memory 206 stores processor-executable instructions which on execution cause the processor 202 to perform the analysis and rendering of each data report of the plurality of pre-generated data reports 208. The memory 206 stores the first data report and the at least one second data report. The memory 206 stores the information of the report contents predefined for each of the first data report and the at least one second data report. In one implementation, the memory 206 stores one or more data relating to analysis of the first data report and the at least one second data report. Particularly, the one or more data are used by the analysis engine 210 and the one or more modules of the processor 202 to perform the comparison and/or the aggregation. The one or more data are explained in detailed in further description of the present disclosure.

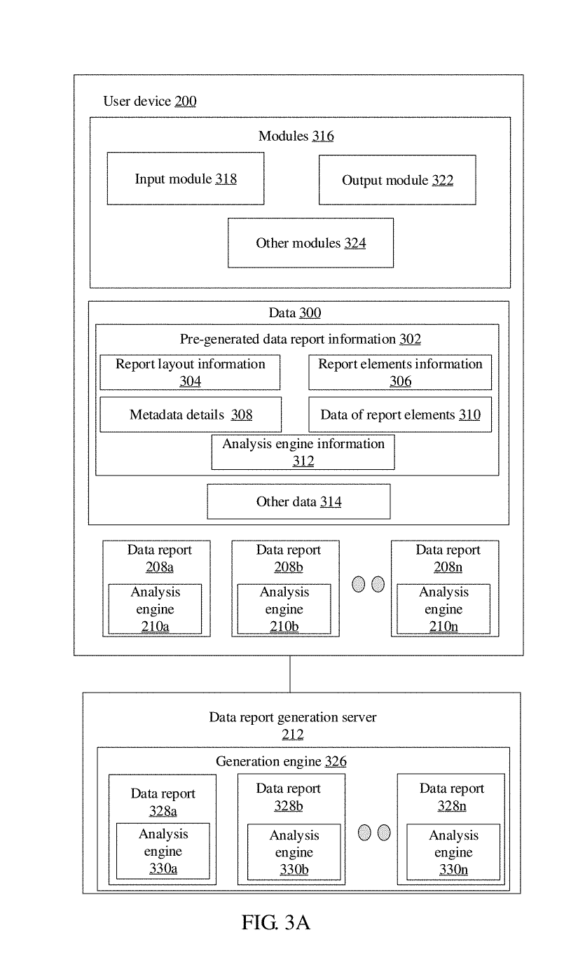

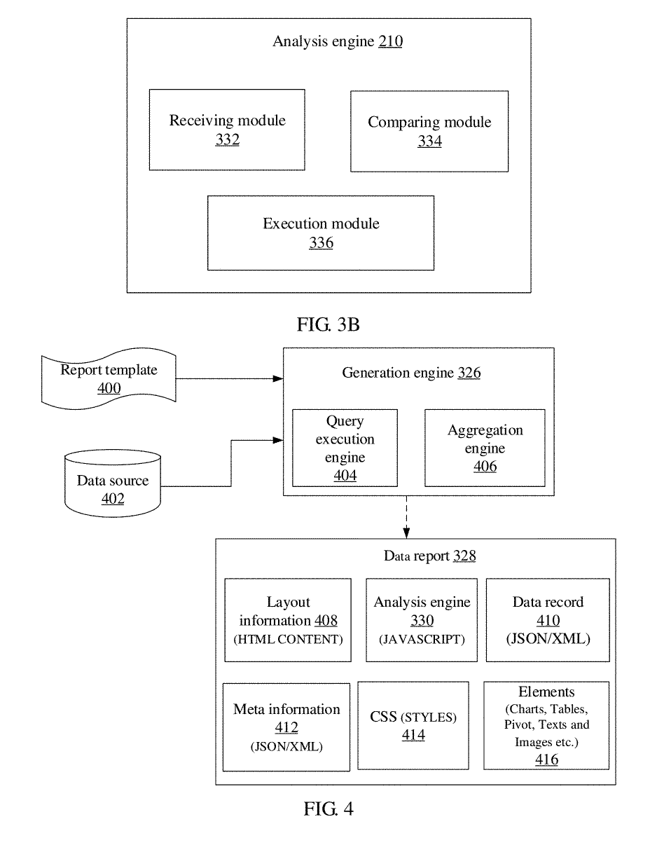

FIG. 3A shows a detailed block diagram illustrating the analysis engine 210 along with various data 300 and modules 316 for analyzing and rendering each data report of the plurality of pre-generated data reports 208 in accordance with some embodiments of the present disclosure.

In an embodiment, the one or more data 300 relating to the offline analysis and rendering of each data report of the plurality of pre-generated data reports 208 are received from the data report generation server 212 after a plurality of data reports 328a, 328b, . . . , 328n (collectively referred to 328) are generated by the data report generation server 212. The generation of each data report of the plurality of data reports 328 by the data report generation server 212 is illustrated herein.

The data report generation server 212 includes a processor (not shown), an I/O interface (not shown) and a memory (not shown). Hence, the data report generation server 212 uses the one or more report templates to generate each data report which comprise the predefined report contents. The I/O interface of the data report generation server 212 is configured to provide the one or more data reports of the plurality of data reports 328 to the one or more user devices 200 for analysis and rendering. In an embodiment, the processor of the data report generation server 212 is configured to generate each data report of the plurality of data reports 328. Particularly, the processor includes a generation engine 326 to generate each data report of the plurality of data reports 328 with the predefined report contents.

The generation engine 326 retrieves a report template including queries, layout details, elements, configuration information of elements and data source of each report template of the one or more report templates (such as Data source 402 shown in FIG. 4). The generation engine 326 includes a query execution engine (not shown) which finds the queries for each of the one or more report templates from the report template and executes the queries to fetch query data. Then, the generation engine 326 generates a data record (such as a data record 410 shown in FIG. 4) including the query data for the queries of each data report. In one example, the generation engine 326 generates an embeddable local data in a predefined format, for example, JAVASCRIPT Object Notation (JSON)/XML format from the fetched query data.

In an embodiment, the elements refer to kind of a visual trend contained by each report template of the one or more report templates. The visual trend may include, but is not limited to, pie chart, bar graphs, histogram, box plots, run charts, forest plots, fan charts, control chart, table and pivot. In an embodiment, the configuration information refers to configuration (i.e. metadata) of the elements. Particularly, the configuration information defines number of the visual trends in the data report like table configuration, number of tables, rows and columns of the tables, entities of the tables, index of the columns, type of the entity, dimension of the entity, size of query results, measure values of the query results, number of fields, key information of the tables, ordering of rows which are accessed, correlation between the columns, correlation between the constraints of the tables, volume of data retrieved from the entities, columns used for grouping the rows, and size of the tables. For example, if an HTML report template has two elements such as an HTML table and an HTML chart. Each element (i.e. the HTML table and the HTML chart) includes configuration information of their own. For example, the table configuration information may contain “XYZ”, “ABC” etc. as table headers which is containing 100 rows per page etc.

In one example, the layout details of each of the one or more report templates in general refer to a part of report template which provides the placement of the elements along with report template style. For example, the layout details may be an XML file. The generation engine 326 generates layout information of each of the one or more data reports using each elements of corresponding report template. In an embodiment, the generation engine 326 generates the layout information (such as a layout information 408 shown in FIG. 4), for example, a layout HTML file of an HTML report with empty placeholders for the elements. In one example, the HTML file defines the layout and the placeholders for each of the elements as shown below:

<html><body onload=″render( )″>
<div class=″report_item″ type=″table″
data=″data/table1.json″
configuration = ″conf/table1conf.xml″></div>
<div class=″report_item″ type= ″chart″
data=″data/table2.json″
configuration=″conf/chart1conf.xml″></div>
</body></html>

In an embodiment, the HTML layout does not contain the formatted contents but contains HTML placeholders. The data in raw form is embedded as structured JSON/XML inside the HTML report.

The generation engine 326 further includes an aggregation engine (not shown) that aggregates or packages the data record, the meta information and the layout information along with the corresponding analysis engine 330a, 330b, . . . , 330n (collectively referred as 330). The aggregated or packaged report is referred as a data report. With respect to FIG. 3A, FIG. 4 shows the plurality of data reports 328 which are created. In the illustrated FIG. 4, the generation engine 326 including the query execution engine 404 and the aggregation engine 406 are shown to generate each of the data report using contents of report template 400. In an embodiment, the aggregation engine 406 can be a packaging engine. The packaging engine packages or combines each data record 410, the meta information 412 (JSON/XML), the layout information 408 (HTML content) and the elements 416 (Charts, Tables, Pivot, Texts, and Images etc.) along with the analysis engine 330 (JAVASCRIPT). In an embodiment, the analysis engine 330 is the analysis engine 210 while performing the analysis. Each of the analysis engine 330 is used for rendering the one or more data reports of the plurality of data reports 328. The analysis engine 330 may be JAVASCRIPT for each of the one or more data reports being pre-generated. Additionally, the aggregation engine 406/packaging engine packages CSS as well which is referred by 414. Each of the pre-generated data reports 328 can be in a format which includes, but is not limited to, HTML, XML, PDF, word format, EXCEL format, and the like. Each of the one or more pre-generated data reports 328 are stored in the memory of the data report generation server 212.

Referring back to FIG. 3A, the user device 200 selects the first data report and the at least one second data report of the plurality of pre-generated data reports 328. Any data report selected in first priority from the plurality of pre-generated data reports 328 is considered to be the first data report. Any data report selected after the first data report is considered to be the at least one second data report. In an embodiment, each pre-generated data reports 328 are rendered dynamically by the analysis engine 330. The rendering of the first data report is explained herein.

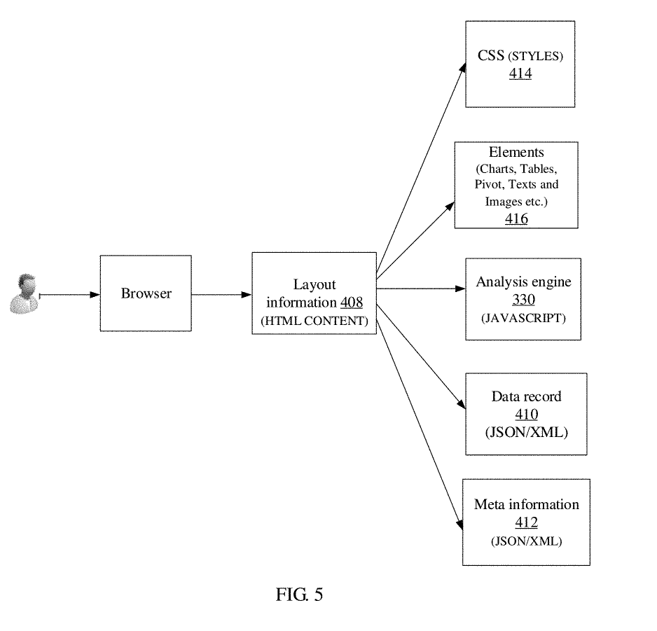

In an embodiment, the analysis engine 330 of each of the one or more data reports among the plurality of data reports 328 renders each of the one or more data report 328 using the elements 416, data record 410, the meta information 412 and the layout information 408. In an embodiment, the analysis engine 330 is configured in respective to one or more data reports to perform rendering. In one implementation, the analysis engine 330 renders each corresponding data reports when the user opens each of the one or more data reports either offline and/or over a browser. FIG. 5 shows an exemplary embodiment of rendering the data report 328. For example, rendering is performed for the HTML file when the user opens the HTML file over the browser. The browser reads the HTML and renders the layout. Then, the browser invokes an on-load and on-document ready operations/functions which are implemented by an analysis engine.js of the analysis engine 330. The analysis engine.js parses a Document Object Model (DOM) structure rendered in the browser and the finds the placeholders for each of the one or more data report 328. For example, the placeholder either table or chart that is found by the analysis engine.js. Then, for each of the elements and the placeholders, the analysis engine.js reads the configuration/meta information and renders the elements. Particularly, for example, from the meta/configuration information, the analysis engine.js finds the data required by the table element, the styles required and the different specific settings such as threshold, formatting, pagination and header etc. The analysis engine.js retrieves the required data from the query data. The analysis engine.js formats the data and renders an HTML snippet for current element information and injects to the DOM. The browser re-renders the display of the HTML file based on the HTML updated dynamically by analysis engine.js. For example, considering the first data report contains tables and chart showing the traffic distribution. Upon rendering by the analysis engine 330 of the first data report, the tables and the chart are displayed for viewing to the user. In such a way, rendering is performed in real-time which is dynamic. For example, consider a traditional report as an HTML file where report elements already rendered as HTML table/image/text along with the style information etc. The user just needs to open the HTML file in any HTML browser to view the traditional report. However, the data report is rendered in real time by the analysis engine 330 by reading the report contents of the data report like layout, element information, element data and style. In such a case, the generated data report (i.e. HTML report) does not contain the report elements in HTML form (like HTML table/image/text). But, the HTML elements are generated in real time by the analysis engine 330 which is rendered dynamically when the data report is opened in the browser.

Upon rendering the first data report, one or more options for analyzing the first data report with other pre-generated data reports 328 are provided. Then, the user is enabled to select the at least one second report among the plurality of pre-generated data reports 328. In an embodiment, the first data report and the at least one second data report can be selected from the data report generation server 212 and/or the user device 200. Upon selecting the first data report and the at least one second data report, the user device 200 receives the one or more data 300 relating to the report contents of each of the selected first data report and the at least one second data report.

In one implementation, as shown in FIG. 3A, the one or more data 300 may include, for example, pre-generated data report information 302 and other data 314 are received by the user device 200. The pre-generated report information 302 includes report layout information 304 which is similar to layout information 408 of FIG. 4, report elements information 306 similar to elements 416 of FIG. 4, metadata details 308 similar to meta information 412 of FIG. 4, data of report elements 310 similar to data record 410 of FIG. 4 and analysis engine information 312 of analysis engine 330. The report layout information 304 refers to the layout information 408 of each of the first data report and the at least one second data report. The report elements information 306 refers to the element information of each of the first data report and the at least one second data report. The metadata information 308 refers to the configuration/meta information of each of the first data report and the at least one second data report. The data of report elements 310 refers to the data for each of the report elements. The analysis engine information 312 refers to the details of the analysis engine 330 contained in each of the corresponding first data report and the at least one second data report. The other data 312 may refer to such data which can be used for analyzing the plurality of pre-generated data reports 208.

In one embodiment, the one or more data 300 may be stored in the memory 206 in the form of various data structures. Additionally, the aforementioned data 300 may be organized using data models, such as relational or hierarchical data models. The other data 314 may be used to store data, including temporary data and temporary files, generated by the one or more modules 316. In an embodiment, the data 300 are processed by the one or more modules 316. The one or more modules 316 may be stored within the memory 206.

The modules 316 may include, for example, an input module 318, an output module 322, and other modules 324 to perform various miscellaneous functionalities of the analysis. It will be appreciated that such aforementioned modules may be represented as a single module or a combination of different modules.

In one implementation, the input module 318 is configured to receive the one or more data reports 328 from the data report generating server 212. Particularly, the selection of each of the first data report and the at least one second data report is received through the input module 318. Then, the analysis of the one or more data reports 328 is performed by the analysis engine 210. In an embodiment, as shown in FIG. 3B, the analysis engine 210 includes a receiving module 332, a comparing module 334 and an execution module 336. The selection of the first data report and the at least one second data report is received by the receiving module 332 of the analysis engine 210. The first data report and the at least one second data report after been received by the receiving module 332 becomes the one or more data report referred by numeral 208. The details on selecting the first data report and the at least one second data report are explained below.

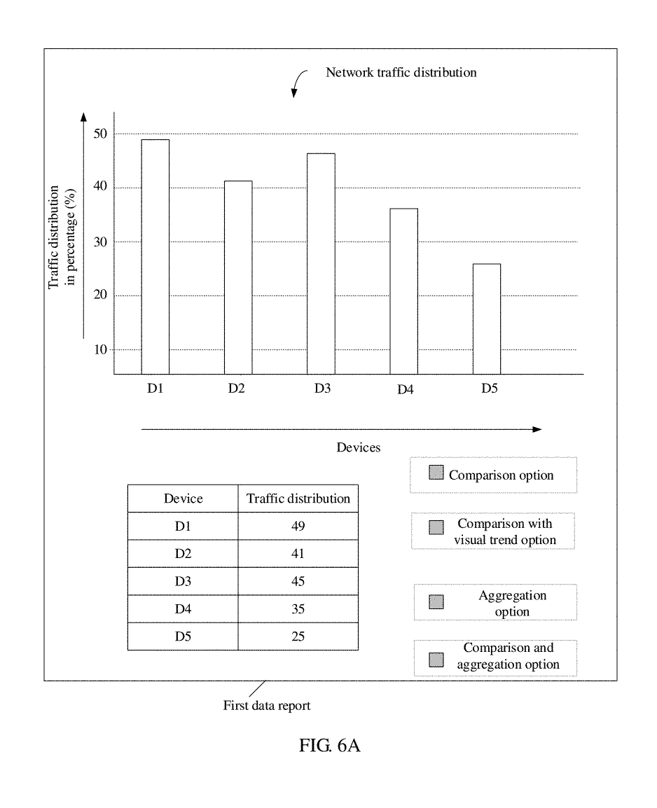

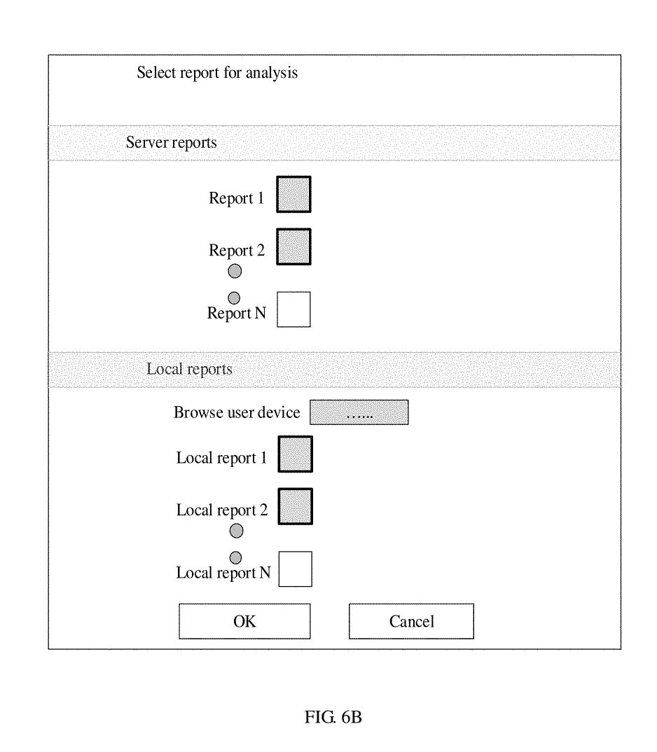

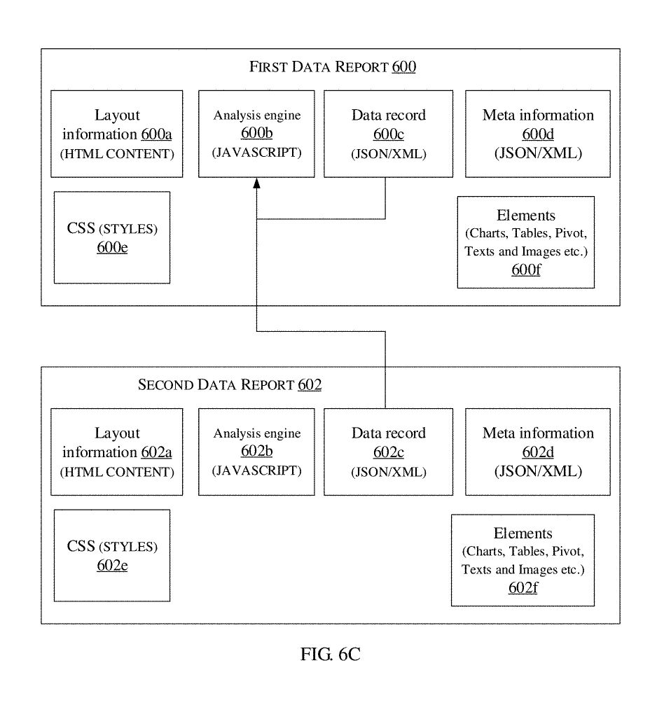

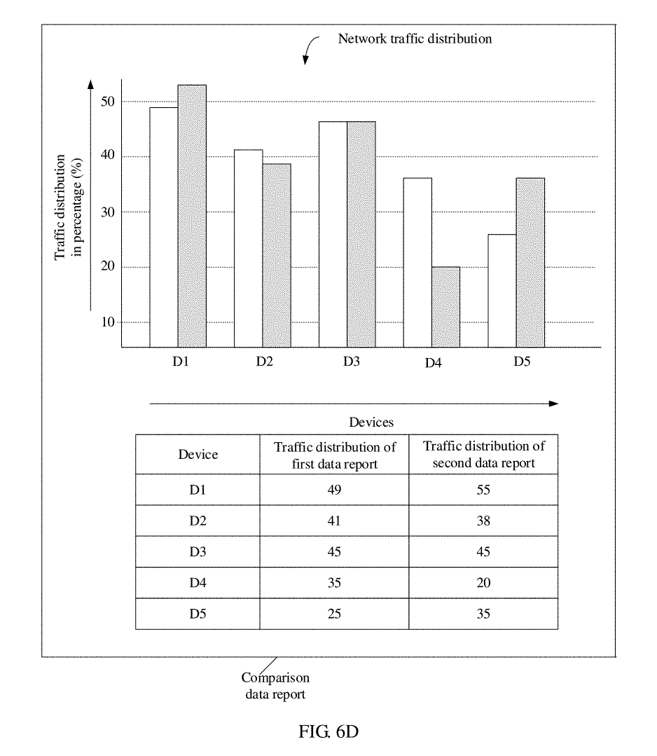

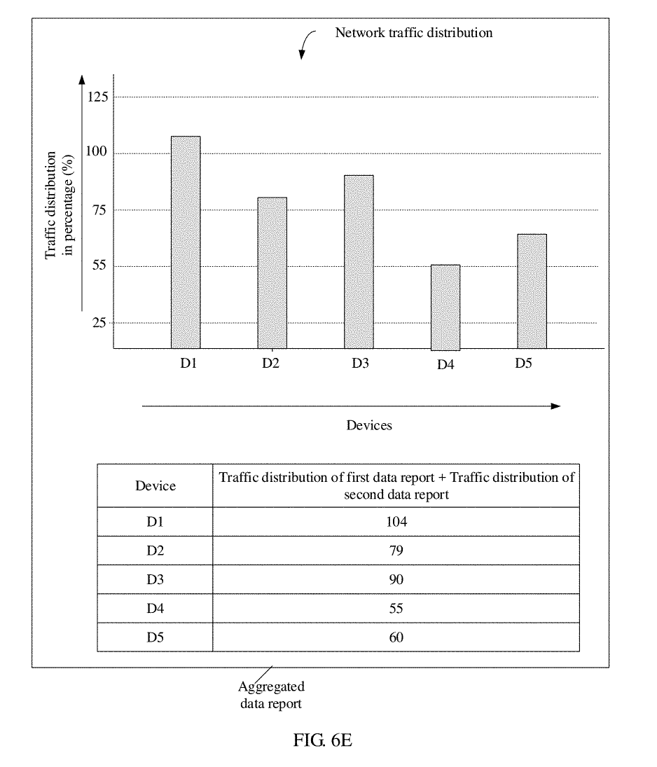

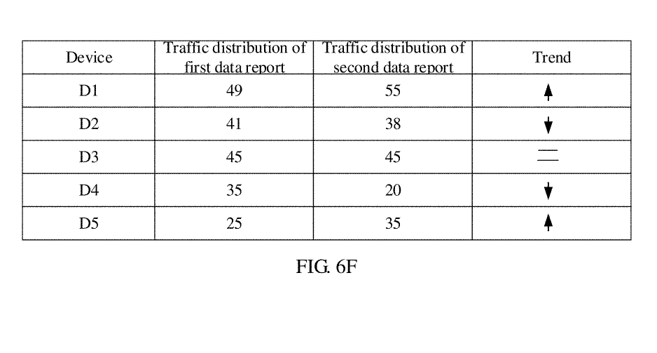

FIG. 6A shows an example for providing the one or more options for analyzing the plurality of pre-generated data reports 328. Upon receiving the selection of the first data report, one or more option for analyzing the first data report with other pre-generated data reports 328 are provided. The options for analyzing such as comparison option, comparison with visual trend option, aggregation option and comparison along with aggregation option are provided. Considering, the user selects comparison option which enables the user to select the at least one second data report among the plurality of pre-generated data reports 328 as shown in FIG. 6B. Upon selecting the at least one second data report, the analysis engine 210 of the first data report is invoked. In an embodiment, the analysis engine 210 provides offline analysis where the user need not be connected to the network connectivity to data report generation server 212. Additionally, the analysis engine 210 is a client side offline engine where the analysis engine 210 is functional from the user device 200. Also, the analysis engine 210 is inbuilt in each of the plurality of pre-generated data reports 208. The comparing module 334 of the analysis engine 210 of the first data report compares the report layout of the first data report with the report layout of the at least one second data report contained. Then, the comparing module 334 of the analysis engine 210 of the first data report determines matching of the report elements and the metadata of the first data report with each of the corresponding report elements and metadata of the at least one second data report. The report elements and the metadata of first data report and the at least one second data report are used during analysis from the report elements information 306 and the metadata details 308. In an embodiment, the analysis engine 210 of the first data report can access the data record 600c and the data record 602c of the first data report 600 and the at least one second data report 602 respectively as shown in FIG. 6C. As shown in FIG. 6C, the first data report 600 further includes layout information 600a (HTML content), elements 600f (Charts, Tables, Pivot, Texts, and Images etc.) along with the analysis engine 600b (JAVASCRIPT), and CSS (styles) 600e. As shown in FIG. 6C, the second data report 602 further includes layout information 602a (HTML content), elements 602f (Charts, Tables, Pivot, Texts, and Images etc.) along with analysis engine 602b (JAVASCRIPT), CSS (styles) 602e, and meta information 602d (JSON/XML). In an embodiment, the execution module 336 of the analysis engine 210 of the first data report generates a comparison report including comparing the data for the report elements of the first data report with the corresponding data for the corresponding report elements of the at least one second data report based on the metadata (i.e. meta information 600d (JSON/XML) and data record 600c) of each of the report elements of the first data report 600 and the at least one second data report 602 respectively as shown in FIG. 6C. FIG. 6D shows the comparison data report being generated for both the bar graphs and the tables.

If the user selects aggregation option, then the execution module 336 of the analysis engine 210 of the first data report generates an aggregated report including combining the data for the report elements of the first data report with the corresponding data for the corresponding report elements of the at least one second data report based on the metadata (i.e. meta information 600d and data record 600c) of each of the report elements of the first data report 600 and the at least one second data report 602 respectively as shown in FIG. 6C. FIG. 6E shows the aggregated data report being generated for both the bar graphs and the tables. In an embodiment, deductions and similarity can also be performed.

If the user selects the comparison with trend option, then one or more trends shows each of the data in the data report as shown in FIG. 6F. In an embodiment, any kind of the one or more trends including, without limitation, increases, decreases, etc. can also be shown.

In an embodiment, each report of each of the generated comparison report and the aggregated report are rendered just like traditional reports. Any browser can be used for viewing such generated comparison/aggregation reports.

The output module 322 provides the results of the analysis provided by the analysis engine 210 in a form of the visual trend for display to the user mapping to the report elements of the first data report.

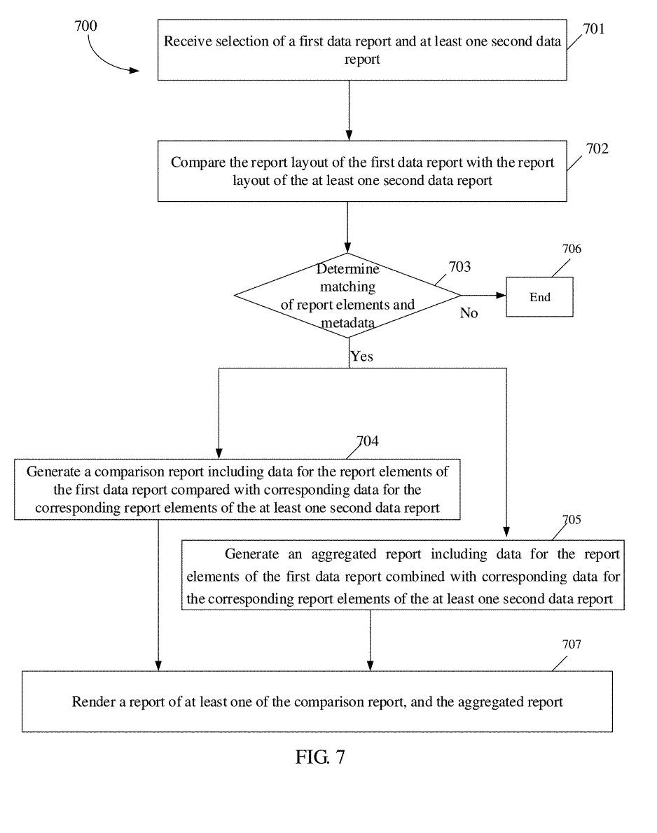

As illustrated in FIGS. 7, 8 and 9, the methods 700, 800 and 900 includes one or more steps for analyzing, generating and rendering the data reports. The methods 700, 800 and 900 may be described in the general context of computer executable instructions. Generally, computer executable instructions can include routines, programs, objects, components, data structures, procedures, modules, and functions, which perform particular functions or implement particular abstract data types.

The order in which the methods 700, 800 and 900 are described is not intended to be construed as a limitation, and any number of the described method steps can be combined in any order to implement the methods 700, 800 and 900. Additionally, individual steps may be deleted from the methods 700, 800 and 900 without departing from the spirit and scope of the subject matter described herein. Furthermore, the methods 700, 800 and 900 can be implemented in any suitable hardware, software, firmware, or combination thereof.

FIG. 7 illustrates a flowchart of method 700 for analyzing a plurality of pre-generated data reports in accordance with some embodiments of the present disclosure.

At step 701, receive selection of a first data report and at least one second data report of a plurality of pre-generated data reports. Each of the plurality of pre-generated data reports includes the report contents having, report elements, a report layout of the report elements, metadata of the report elements and data of the report elements.

At step 702, compare the report layout of the first data report with the report layout of the at least one second data report.

At step 703, determine a condition whether the report elements and the metadata of the first data report matches with each of the corresponding report elements and metadata of the at least one second data report based on comparison. If no, the process is ended via “NO” at step 706. Particularly, if the report elements and the metadata of the first data report do not match with report elements and metadata of the second data report, then non-matching reports are excluded from the comparison/aggregation and other matching reports (among the selected reports) will be compared/aggregated as illustrated in steps 704 and 705.

At step 704, generate a comparison report including data for the report elements of the first data report compared with corresponding data for the corresponding report elements of the at least one second data report.

At step 705, generate an aggregated report including data for the report elements of the first data report combined with corresponding data for the corresponding report elements of the at least one second data report.

At step 707, render the report of at least one of the comparison report, and the aggregated report.

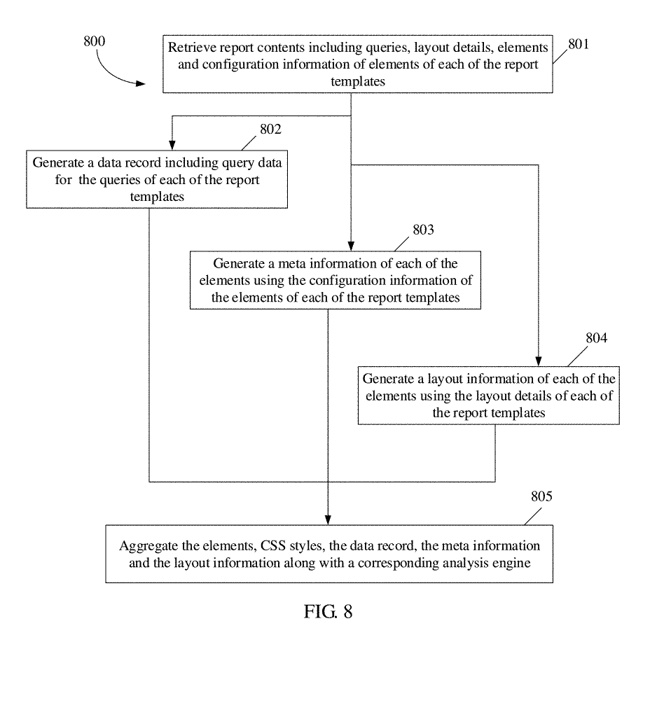

FIG. 8 illustrates a flowchart of method 800 for generation of the plurality of data reports in accordance with some embodiments of the present disclosure.

At step 801, retrieve the report contents including the queries, the layout details, the elements and the configuration information of elements of each of the report templates.

At step 802, generate the data record including the query data for the queries of each of the report templates.

At step 803, generate the meta information of each of elements using the configuration information of the elements of each of the report templates.

At step 804, generate the layout information of each of the elements using the layout details of each of the report templates.

At step 805, aggregate the elements, the data record, the meta information, CSS styles, and the layout information along with the corresponding analysis engine.

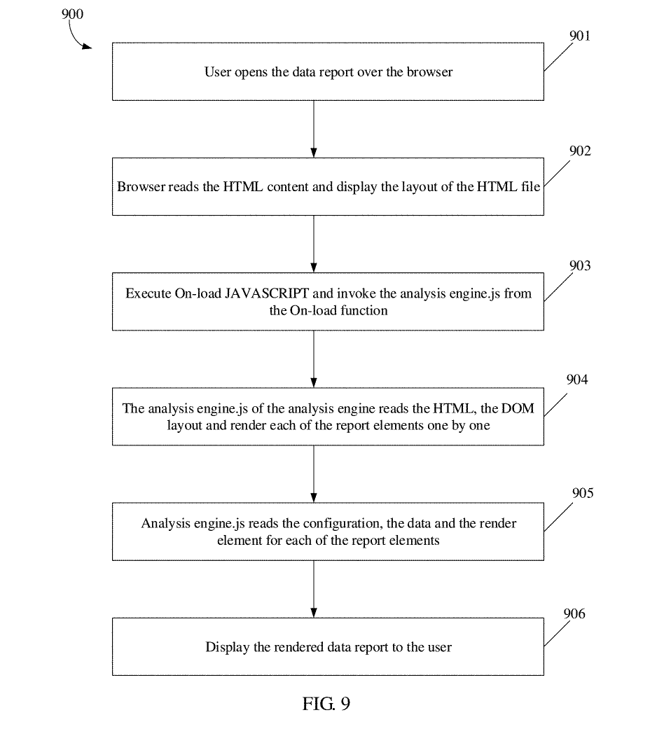

FIG. 9 illustrates a flowchart of method 900 for rendering each of the report contents to generate a data report in accordance with some embodiments of the present disclosure.

At step 901, the user opens the data report over the browser by the analysis engine.js.

At step 902, the browser reads the HTML content and display the layout of the HTML file.

At step 903, execute On-load JAVASCRIPT function and invoke the analysis engine.js from the On-load function.

At step 904, the analysis engine.js of the analysis engine reads the HTML, the DOM layout and render each of the report elements one by one.

At step 905, the analysis engine.js reads the configuration, the data and the render element for each of the report elements.

At step 906, display the rendered data report to the user.

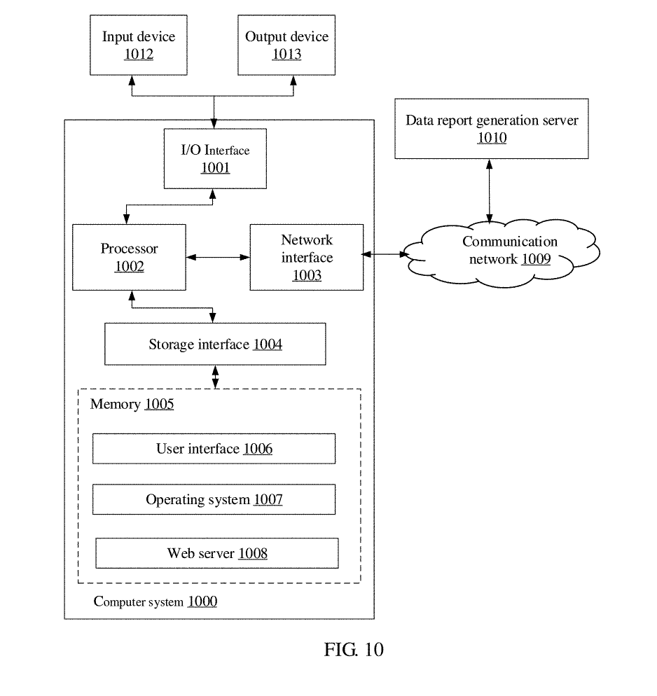

FIG. 10 illustrates a block diagram of an exemplary computer system 1000 for implementing embodiments consistent with the present disclosure. In an embodiment, the computer system 1000 is used to implement the foregoing analysis engine of data report and the user device. The computer system 1000 may comprise a processor 1002. The processor 1002 may comprise at least one data processor for executing program components for analyzing the plurality of pre-generated data reports. The processor 1002 may include specialized processing units such as integrated system (bus) controllers, memory management control units, floating point units, graphics processing units, digital signal processing units, etc.

The processor 1002 may be disposed in communication with one or more I/O devices (1012 and 1013) via I/O interface 1001. The I/O interface 1001 may employ communication protocols/methods such as, without limitation, audio, analog, digital, monaural, RCA, stereo, the Institute of Electrical and Electronics Engineers-1394 (IEEE-1394), serial bus, universal serial bus (USB), infrared, PS/2, BNC, coaxial, component, composite, digital visual interface (DVI), high-definition multimedia interface (HDMI), radio frequency (RF) antennas, S-Video, Video Graphics Array (VGA), IEEE 802.n/b/g/n/x, BLUETOOTH, cellular (e.g., code-division multiple access (CDMA), high-speed packet access (HSPA+), global system for mobile communications (GSM), long-term evolution (LTE), Worldwide Interoperability for Microwave Access (WIMAX), or the like), etc.

The I/O interface(s) 1001 may include a variety of software and hardware interfaces, for example, a web interface, a graphical user interface, etc. Using the I/O interface 1001, the computer system 1000 may communicate with one or more I/O devices (1012 and 1013). For example, the input device 1012 may be an antenna, keyboard, mouse, joystick, (infrared) remote control, camera, card reader, fax machine, dongle, biometric reader, microphone, touch screen, touchpad, trackball, sensor (e.g., accelerometer, light sensor, Global Positioning System (GPS), gyroscope, proximity sensor, or the like), stylus, scanner, storage device, transceiver, video device/source, visors, etc. The output device 1013 may be a printer, fax machine, video display (e.g., cathode ray tube (CRT), liquid crystal display (LCD), light-emitting diode (LED), plasma, or the like), audio speaker, etc.

In some embodiments, the processor 1002 may be disposed in communication with a communication network 1009 via a network interface 1003. The network interface 1003 may communicate with the communication network 1009. The network interface 1003 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 1009 may include, without limitation, a direct interconnection, local area network (LAN), wide area network (WAN), wireless network (e.g., using Wireless Application Protocol (WAP)), the Internet, etc. Using the network interface 1003 and the communication network 1009, the computer system 1000 may communicate with data report generation server 1010. The network interface 1003 may employ connection protocols include, but not limited to, direct connect, Ethernet (e.g., twisted pair 10/100/1000 Base T), TCP/IP, token ring, IEEE 802.11a/b/g/n/x, etc.

The communication network 1009 includes, but is not limited to, a direct interconnection, an e-commerce network, a peer to peer (P2P) network, LAN, WAN, wireless network (e.g., using WAP), the Internet, WI-FI and such. The first network and the second network may either be a dedicated network or a shared network, which represents an association of the different types of networks that use a variety of protocols, for example, Hypertext Transfer Protocol (HTTP), TCP/IP, WAP, etc., to communicate with each other. Further, the first network and the second network may include a variety of network devices, including routers, bridges, servers, computing devices, storage devices, etc.

In some embodiments, the processor 1002 may be disposed in communication with a memory 1005 (e.g., random access memory (RAM), read-only memory (ROM), etc. not shown in FIG. 10) via a storage interface 1004. The storage interface 1004 may connect to memory 1005 including, without limitation, memory drives, removable disc drives, etc., employing connection protocols such as serial advanced technology attachment (SATA), integrated drive electronics (IDE), IEEE-1394, USB, fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 1005 may store a collection of program or database components, including, without limitation, user interface 1006, an operating system 1007, web server 1008 etc. In some embodiments, computer system 1000 may store user/application data, such as the data, variables, records, etc. as described in this disclosure. Such databases may be implemented as fault-tolerant, relational, scalable, secure databases such as Oracle or Sybase.

The operating system 1007 may facilitate resource management and operation of the computer system 1000. Examples of operating systems include, without limitation, APPLE MACINTOSH operating system X, UNIX, UNIX-like system distributions (e.g., Berkeley Software Distribution (BSD), FREEBSD, NETBSD, OpenBSD, etc.), LINUX distributions (e.g., RED HAT, UBUNTU, KUBUNTU, etc.), International Business Machines (IBM) operating system/2, MICROSOFT WINDOWS (XP, VISTA/7/8, etc.), APPLE IOS, GOOGLE ANDROID, BLACKBERRY operating system, or the like. User interface 1006 may facilitate display, execution, interaction, manipulation, or operation of program components through textual or graphical facilities. For example, user interface 1006 may provide computer interaction interface elements on a display system operatively connected to the computer system 1000, such as cursors, icons, check boxes, menus, scrollers, windows, widgets, etc. Graphical user interfaces (GUIs) may be employed, including, without limitation, APPLE MACINTOSH operating systems' AQUA, IBM operating system/2, MICROSOFT WINDOWS (e.g., AERO, METRO, etc.), UNIX X-Windows, web interface libraries (e.g., ActiveX, JAVA, JAVASCRIPT, AJAX, HTML, ADOBE FLASH, etc.), or the like.

In some embodiments, the computer system 1000 may implement a web browser 1008 stored program component. The web browser may be a hypertext viewing application, such as MICROSOFT INTERNET EXPLORER, GOOGLE CHROME, MOZILLA FIREFOX, APPLE SAFARI, etc. Secure web browsing may be provided using HTTPS (secure HTTP), secure sockets layer (SSL), Transport Layer Security (TLS), etc. Web browsers may utilize facilities such as AJAX, dynamic HTML (DHTML), ADOBE FLASH, JAVASCRIPT, JAVA, application programming interfaces (APIs), etc. In some embodiments, the computer system 1000 may implement a mail server stored program component. The mail server may be an Internet mail server such as MICROSOFT EXCHANGE, or the like. The mail server may utilize facilities such as ASP, ActiveX, American National Standards Institute (ANSI) C++/C#, MICROSOFT .NET, Computer-generated imagery (CGI) scripts, JAVA, JAVASCRIPT, PERL, PHP, PYTHON, WebObjects, etc. The mail server may utilize communication protocols such as internet message access protocol (IMAP), messaging application programming interface (MAPI), MICROSOFT EXCHANGE, post office protocol (POP), simple mail transfer protocol (SMTP), or the like. In some embodiments, the computer system 1000 may implement a mail client stored program component. The mail client may be a mail viewing application, such as APPLE MAIL, MICROSOFT ENTOURAGE, MICROSOFT OUTLOOK, MOZILLA THUNDERBIRD, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include RAM, ROM, volatile memory, nonvolatile memory, hard drives, compact disc (CD) ROMs, digital versatile discs (DVDs), flash drives, disks, and any other known physical storage media.

Additionally, advantages of present disclosure are illustrated herein.

Embodiments of the present disclosure provide faster analysis including the comparison and the aggregation. The aspect of manual generation of data report is eliminated and hence dynamic creation of the data report is carried by the present disclosure. Additionally, the creation of the visual trend showing the analysis is implemented which is limited in the prior arts.

Embodiments, of the present disclosure provide analysis of any kind of data reports having any report format. The aspect generation of a standard and sophisticated report template for the data report for performing the analysis is carried in the present disclosure.

The described operations may be implemented as a method, system or article of manufacture using standard programming and/or engineering techniques to produce software, firmware, hardware, or any combination thereof. The described operations may be implemented as code maintained in a “non-transitory computer readable medium,” where a processor may read and execute the code from the computer readable medium. The processor is at least one of a microprocessor and a processor capable of processing and executing the queries. A non-transitory computer readable medium may comprise media such as magnetic storage medium (e.g., hard disk drives, FLOPPY DISKs, tape, etc.), optical storage (CD-ROMs, DVDs, optical disks, etc.), volatile and non-volatile memory devices (e.g., electrically erasable programmable ROMs (EEPROMs), ROMs, programmable ROMs (PROMs), RAMs, dynamic RAMs (DRAMs), static RAMs (SRAMs), Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals,” where transmission signals may propagate through space or through a transmission media, such as an optical fiber, copper wire, etc. The transmission signals in which the code or logic is encoded may further comprise a wireless signal, satellite transmission, radio waves, infrared signals, BLUETOOTH, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” includes non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the disclosure, and that the article of manufacture may comprise suitable information bearing medium known in the art.

The terms “an embodiment,” “embodiment,” “embodiments,” “the embodiment,” “the embodiments,” “one or more embodiments,” “some embodiments,” and “one embodiment” mean “one or more (but not all) embodiments of the disclosure(s)” unless expressly specified otherwise.

The terms “including,” “comprising”, “having” and variations thereof mean “including but not limited to,” unless expressly specified otherwise.

The enumerated listing of items does not imply that any or all of the items are mutually exclusive, unless expressly specified otherwise.

The terms “a,” “an” and “the” mean “one or more,” unless expressly specified otherwise.

A description of an embodiment with several components in communication with each other does not imply that all such components are required. On the contrary, a variety of optional components are described to illustrate the wide variety of possible embodiments of the disclosure.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

The illustrated operations of FIGS. 7, 8 and 9 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the present disclosure are intended to be illustrative, but not limiting, of the scope of the disclosure, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A method for analyzing pre-generated data reports, comprising:
receiving selection of a first data report and at least one second data report of a plurality of pre-generated data reports, wherein each of the plurality of pre-generated data reports comprises report elements, a report layout of the report elements, metadata of the report elements and data of the report elements;
comparing a report layout of the first data report with a report layout of the at least one second data report; and
wherein when report elements and metadata of the first data report match with each of corresponding report elements and metadata of the at least one second data report based on the comparison, the method further comprises performing at least one of:
generating a comparison report comprising data for the report elements of the first data report compared with corresponding data for the corresponding report elements of the at least one second data report; and
generating an aggregated report comprising the data for the report elements of the first data report combined with the corresponding data for the corresponding report elements of the at least one second data report.

2. The method as claimed in claim 1, wherein each data report of the plurality of data reports is generated by retrieving queries, layout details, elements, and configuration information of elements of each of report templates, wherein the method further comprises performing at least one of:
generating a data record comprising query data for the queries of each of the report templates;
generating meta information of each of the elements using the configuration information of the elements of each of the report templates; and
generating layout information of each of the elements using the layout details of each of the report templates, and
wherein the method further comprises aggregating the data record, the meta information and the layout information of each of the report templates along with a corresponding analysis engine to generate each data report of the plurality of data reports by the analysis engine.

3. The method as claimed in claim 2, further comprising dynamically rendering each data report by the analysis engine using the elements of each of the report templates, the data record, the meta information and the layout information contained in the data report.

4. The method as claimed in claim 1, wherein the comparison report is generated based on the metadata of each of the report elements of the first data report and the at least one second data report.

5. The method as claimed in claim 1, wherein the aggregated report is generated based on the metadata of each of the report elements of the first data report and the at least one second data report.

6. The method as claimed in claim 1, further comprising generating, by the analysis engine, a visual trend for each of the data of the report elements for the comparison report.

7. A user device, comprising:
at least one processor;
an Input/Output (I/O) interface coupled to the at least one processor; and
a memory coupled to the at least one processor,
wherein the I/O interface is configured to receive a plurality of data reports pre-generated by a data report generation server,
wherein the at least one processor is configured to:
receive selection of a first data report and at least one second data report of the plurality of data reports, wherein each of the plurality of data reports comprises report elements, a report layout of the report elements, metadata of the report elements and data of the report elements;
compare a report layout of the first data report with a report layout of the at least one second data report, and
wherein when report elements and metadata of the first data report match with each of corresponding report elements and metadata of the at least one second data report based on the comparison, the at least one processor is further configured to perform at least one of:
generate a comparison report comprising data for the report elements of the first data report compared with corresponding data for the corresponding report elements of the at least one second data report; and
generate an aggregated report comprising the data for the report elements of the first data report combined with the corresponding data for the corresponding report elements of the at least one second data report.

8. The user device as claimed in claim 7, wherein the at least one processor is further configured to:
retrieve queries, layout details, elements, and configuration information of elements of each report templates;
perform at least one of:
generate a data record comprising query data for the queries of each of the report templates;
generate meta information of each of the elements using the configuration information of the elements of each report templates; and
generate layout information of each of the elements using the layout details of each of the report templates; and
aggregate the data record, the meta information and the layout information of each of the report templates along with a corresponding analysis engine to generate each data report of the plurality of data reports.

9. The user device as claimed in claim 8, wherein the at least one processor is further configured to dynamically render each data report using the elements of each of the report templates, the data record, the meta information and the layout information contained in the data report.

10. The user device as claimed in claim 7, wherein the at least one processor is further configured to generate the comparison report based on the metadata of each of the report elements of the first data report and the at least one second data report.

11. The user device as claimed in claim 7, wherein the at least one processor is further configured to generate the aggregated report based on the metadata of each of the report elements of the first data report and the at least one second data report.

12. The user device as claimed in claim 7, wherein the at least one processor is further configured for generate a visual trend for each data of the report elements for the comparison report.

13. A non-transitory computer readable medium including instructions stored thereon, which, when executed by at least one processor, will cause an analysis engine to perform a method comprising:
receiving selection of a first data report and at least one second data report of a plurality of pre-generated data reports, wherein each of the plurality of pre-generated data reports comprises report elements, a report layout of the report elements, metadata of the report elements and data of the report elements;
comparing a report layout of the first data report with a report layout of the at least one second data report; and
wherein when report elements and metadata of the first data report match with each of corresponding report elements and metadata of the at least one second data report based on the comparison, the method further comprises performing at least one of:
generating a comparison report comprising data for the report elements of the first data report compared with corresponding data for the corresponding report elements of the at least one second data report; and
generating an aggregated report comprising the data for the report elements of the first data report combined with the corresponding data for the corresponding report elements of the at least one second data report.

14. The non-transitory computer readable medium of claim 13, wherein each data report of the plurality of data reports is generated by retrieving queries, layout details, elements, and configuration information of elements of each of report templates, wherein the non-transitory computer readable medium further storing instructions for execution by the at least one processing processor, so as to:
generate a data record comprising query data for the queries of each of the report templates;
generate meta information of each of the elements using the configuration information of the elements of each of the report templates; and
generate layout information of each of the elements using the layout details of each of the report templates, and
aggregate the data record, the meta information and the layout information of each of the report templates along with a corresponding analysis engine to generate each data report of the plurality of data reports by the analysis engine.

15. The non-transitory computer readable medium of claim 14, wherein the non-transitory computer readable medium further storing instructions for execution by the at least one processing processor, so as to: dynamically rendering each data report by the analysis engine using the elements of each of the report templates, the data record, the meta information and the layout information contained in the data report.

16. The non-transitory computer readable medium of claim 13, wherein the comparison report is generated based on the metadata of each of the report elements of the first data report and the at least one second data report.

17. The non-transitory computer readable medium of claim 13, wherein the aggregated report is generated based on the metadata of each of the report elements of the first data report and the at least one second data report.

18. The non-transitory computer readable medium of claim 13, the non-transitory computer readable medium further storing instructions for execution by the at least one processing processor, so as to: generate a visual trend for each of the data of the report elements for the comparison report.
